(19) United States
(12) Patent Application Publication
(10) Pub. No.: US 2026/0118063 A1
(43) Pub. Date: Apr. 30, 2026

(54) HEAT TREATMENT DEVICE

(71) Applicants: ACM RESEARCH (SHANGHAI), INC., Shanghai (CN); ACM Research Korea CO., LTD., Icheon-Si (KR); CleanChip Technologies Limited, Hong Kong (CN)

(72) Inventors: Mark Lee, Icheon-Si (KR); Jun Wu, Shanghai (CN); Hui Wang, Shanghai (CN); Cheng Cheng, Shanghai (CN); Andrew Jung, Icheon-Si (KR); Bruce Sohn, Icheon-Si (KR); Wenjun Wang, Shanghai (CN); Qian Shao, Shanghai (CN); Jun Wang, Shanghai (CN); Deyun Wang, Shanghai (CN); Yy Kim, Icheon-Si (KR)

(73) Assignees: ACM RESEARCH (SHANGHAI), INC., Shanghai (CN); ACM Research Korea CO., LTD., Icheon-Si (KR); CleanChip Technologies Limited, Hong Kong (CN)

(21) Appl. No.: 19/115,735

(22) PCT Filed: Jul. 26, 2023
(86) PCT No.: PCT/CN2023/109218

§ 371 Date: Mar. 26, 2025

(30) Foreign Application Priority Data
Sep. 29, 2022 (CN) 202211203651.1

(51) Int. Cl. F27D 9/00; F27D 3/00

(52) U.S. Cl. CPC F27D 9/00; F27D 3/0084; F27D 2003/0046; F27D 2009/0002

(57) ABSTRACT

The invention relates to an equipment for semiconductor production, in particular to a heat treatment apparatus. The apparatus comprises a cooling unit (200), a heating unit (300) and a transmission unit (400). The cooling unit (200) comprises a cooling plate (210) for cooling a substrate (w), and the heating unit (300) comprises a heating plate (310) for heating the substrate (w). The transmission unit (400) comprises a transmission arm (410), a lifting module and a linear module. The transmission arm (410) supports the substrate (w) and transmits the substrate (w) between the cooling unit (200) and the heating unit (300). The transmission arm (410) is disposed on the lifting module, and the lifting module drives the transmission arm (410) to ascend and descend. The linear module drives the transmission arm (410) to transmit the substrate (w) between the cooling plate (210) and the heating plate (310). The internal space of the apparatus is optimized.

### FIELD OF THE INVENTION

The present invention relates to an equipment for semiconductor production, and in particular to a heat treatment apparatus.

### BACKGROUND

Currently, a semiconductor device is fabricated on a semiconductor substrate such as a wafer by performing a series of processes such as thin film deposition process, photolithography process, etching process and cleaning process. The photolithography process refers to pattern a thin film deposited on a substrate, including a process of forming a photoresist film by applying the photoresist liquid on the substrate by a coating apparatus, an exposure process of irradiating the light having a predetermined pattern onto the substrate, a development process of applying the developing solution to the photoresist film by a developing apparatus to form a photoresist pattern, and the like.

The coating apparatus comprises a heat treatment apparatus, for a heat treatment on the substrate before and after the process of applying the photoresist liquid onto the substrate. In addition, the developing apparatus also comprises a heat treatment apparatus, for a heat treatment on the substrate before and after performing the development process on the substrate.

In the prior art, the heat treatment apparatus comprises a heating unit for heating the substrate and a cooling unit for cooling the substrate. The internal space of the heat treatment apparatus is limited, so it is urgent to solve the problem of how to arrange each device in the limited space.

### SUMMARY

In view of the above-described problems, an object of the present invention is to provide a heat treatment apparatus, which optimizes the layout and structure of each component.

In order to realize the above object, the present invention provides the following technical solutions:

A heat treatment apparatus, comprising a cooling unit, a heating unit and a transmission unit, the cooling unit comprising a cooling plate for cooling a substrate, the heating unit comprising a heating plate for heating the substrate, the transmission unit comprising a transmission arm, a lifting module and a linear module, the transmission arm being movably disposed on the lifting module, the lifting module being disposed on the linear module, the lifting module driving the transmission arm to ascend and descend, the transmission arm being used to support the substrate, and the linear module driving the transmission arm to transmit the substrate between the cooling plate and the heating plate.

Compared to the prior art, the heat treatment apparatus of the present invention has the following beneficial effects:

The cooling unit and the heating unit are integrated in one heat treatment apparatus. The linear module is disposed, so that the transmission arm can be moved between the cooling unit and the heating unit to move the substrate without moving the cooling unit. And the transmission arm can be ascended and descended driven by the lifting module to pick and place the substrate, so that the pick-and-place devices are avoided to dispose at the positions of the cooling unit and the heating unit respectively. The space occupation is reduced, and the internal space of the heat treatment apparatus is optimized.

### BRIEF DESCRIPTION OF THE DRAWINGS

In order to more clearly explain the embodiments of the present invention or the technical solutions in the prior art, the drawings that need to be used in the description of the embodiments or the prior art will be briefly introduced below. It is obvious that the drawings in the following description are only some embodiments of the present invention, and for those of ordinary skill in the art, other drawings can be obtained according to these drawings on the premise of not paying creative labor.

FIG. 1 is a perspective view of a heat treatment apparatus according to embodiment 1 of the present invention;

FIG. 2 is a top view of a heat treatment apparatus according to embodiment 1 of the present invention;

FIG. 3 is a schematic structural diagram of a transmission unit according to embodiment 1 of the present invention;

FIG. 4 is a schematic structural diagram of a transmission unit according to embodiment 2 of the present invention;

FIG. 5 is a schematic structural diagram of a transmission unit according to embodiment 3 of the present invention;

FIG. 6 is a schematic structural diagram of a transmission unit according to embodiment 4 of the present invention;

FIG. 7 is a schematic flow diagram of an exemplary substrate transmission method according to embodiment 5 of the present invention;

FIG. 8 is a schematic structural diagram of a substrate transmission method according to embodiment 5 of the present invention.

### PREFERRED EMBODIMENTS OF THE INVENTION

In order to make the objects, features, and advantages of the present invention more obvious and easier to understand, the technical solutions in the embodiments of the present invention will be clearly and completely described below with reference to the accompanying drawings in the embodiments of the present invention. It is obvious that the embodiments described below are only some embodiments of the present invention, but not all embodiments. Based on the embodiments of the present invention, all other embodiments obtained by those of ordinary skill in the art on the premise of not paying creative labor belong to the scope of protection of the present invention.

In the description of the present invention, it is to be understood that when one component is considered to be “connected” to another component, the component may be directly connected to another component or there may be a component disposed in the center at the same time. When a component is considered to be “disposed” on another component, the component may be a component disposed directly on another component or there may be a component disposed in the center at the same time.

Hereinafter, the technical solutions of the present invention will be further described with reference to the accompanying drawings and specific embodiments.

### First Embodiment

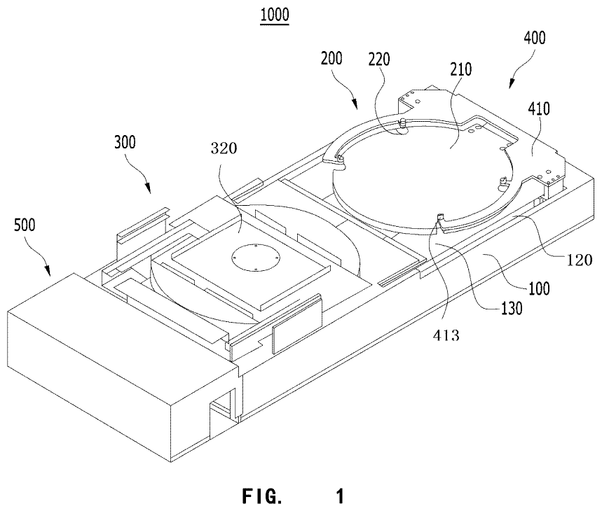

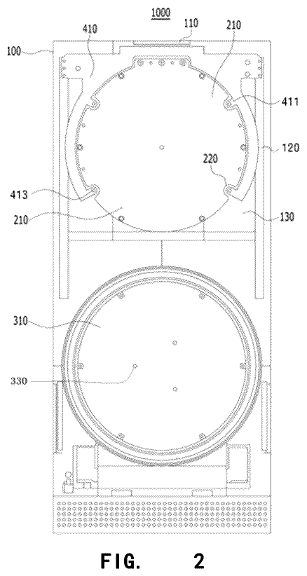

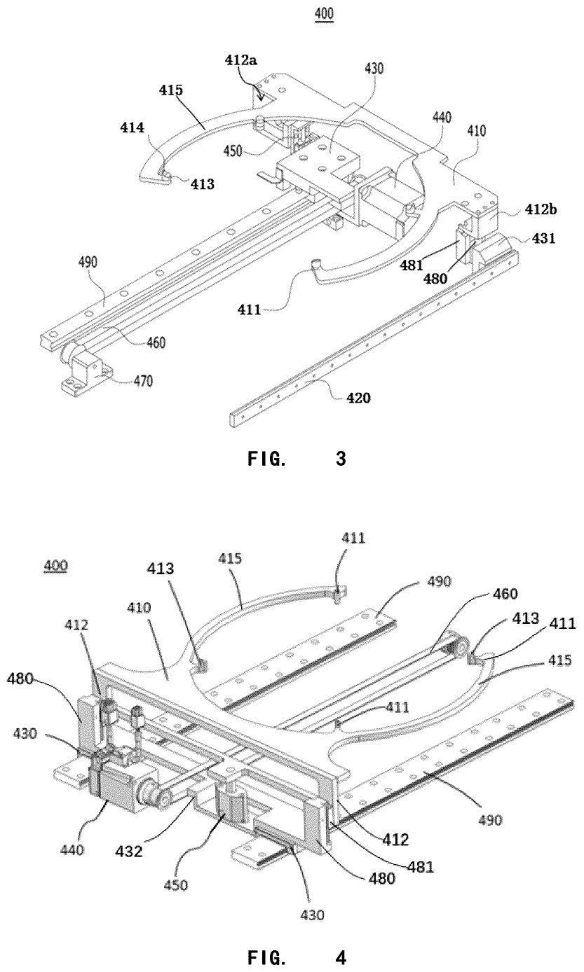

Referring to FIGS. 1 to 3, the present embodiment provides a heat treatment apparatus, and the apparatus 1000 comprises a housing, a cooling unit 200, a heating unit 300, a transmission unit 400 and a control unit 500.

The housing is provided with an opening 110, and the substrate enters the apparatus 1000 or moves out of the apparatus 1000 by the opening 110. The cooling unit 200, the heating unit 300 and the transmission unit 400 are each connected to the control unit 500 and provided in the housing. The control unit 500 is used for controlling the work of the cooling unit 200, the heating unit 300 and the transmission unit 400.

The cooling unit 200 comprises a cooling plate 210 for supporting and cooling the substrate. The heating unit 300 comprises a heating plate 310 for supporting and heating the substrate.

The transmission unit 400 is disposed in the housing and mounted on a side of the cooling unit 200 away from the heating unit 300. The transmission unit 400 comprises a transmission arm 410, a lifting module and a linear module. The transmission arm 410 is movably disposed on the lifting module, and the lifting module is movably disposed on the linear module. The transmission arm 410 is used to support the substrate and can move between the cooling unit 200 and the heating unit 300 under the driving of the linear module.

During the work process, the control unit 500 controls the lifting module and the linear module to work. The transmission arm 410 is disposed on the lifting module, and the lifting module drives the transmission arm 410 to ascend and descend. The linear module drives the transmission arm 410 to move linearly between above the cooling plate 210 and above the heating plate 310.

Specifically, the lifting module comprises a first driving unit 450, a first sliding member 481 and a first guiding rail 480. The first sliding member 481 is slidably disposed on the first guiding rail 480. The linear module comprises a first moving member 430, a second driving unit 440, a conveyor belt 460, a second guiding rail 490, a second moving member 431 and an auxiliary guiding rail 420. The second guiding rail 490 are disposed in the housing, and the first moving member 430 is movably mounted on the second guiding rail 490 and disposed on the conveyor belt 460. The first driving unit 450 is disposed on the first moving member 430. The auxiliary guiding rail 420 is disposed on one side of the second guiding rail 490, and is disposed spaced apart from the second guiding rail 490. The second moving member 431 is movably disposed on the auxiliary guiding rail 420. The first guiding rail 480 is disposed on the second moving member 431. In the present embodiment, the first driving unit 450 is a slide cylinder, and the slide cylinder comprises an L-shaped second sliding member and a driving member. The driving member is a cylinder assembly, and the cylinder assembly is provided with a track inside. The driving member drives the second sliding member to move on the track.

The second driving unit 440 drives the conveyor belt 460 to work, and the conveyor belt 460 drives the first moving member 430 to slide on the second guiding rail 490. The first moving member 430 moves together with the lifting module, the transmission arm 410 and the second moving member 431. The second driving unit 440 drives the second moving member 431 to slide on the auxiliary guiding rail 420 and the first moving member 430 to slide on the second guiding rail 490 at the same time. The arrangement of the auxiliary guiding rail 420 increases the movement rate of the transmission arm 410 and enhances the stability of the apparatus.

The transmission unit 400 further comprises two supporting members 412a, 412b. Two supporting members 412a, 412b are disposed on the transmission arm 410, respectively. One side of the supporting member 412a is disposed on the second sliding member of the first driving unit 450. One side of the supporting member 412b is disposed on the first sliding member 481. When the second sliding member is driven to move, the supporting member 412a moves with the second sliding member to drive the transmission arm 410 and the other supporting member 412b to move together, that is, the transmission arm 410 slides by the supporting members 412a and 412b together to realize ascending and descending. The first driving unit 450 is used to drive the two supporting members 412a, 412b to move synchronously, so that the supporting members 412a, 412b on both sides are ascended and descended at the same rate.

The supporting member 412a is driven by the first driving unit 450 to ascend and descend, so as to drive the transmission arm 410 to ascend and descend. The transmission arm 410 can be ascended in the upright direction to load and support the substrate, and can be descended in the upright direction to unload the substrate.

Optionally, the first moving member 430 is removed, and the first driving unit 450 is directly and movably disposed on the second guiding rail 490. And the first driving unit 450 moves linearly on the second guiding rail 490.

In one optional embodiment, the supporting members 412a, 412b and the transmission arm 410 are integrally formed. Further, the linear module further comprises a base 470, and the base 470 is disposed on the bottom surface inside the housing. The conveyor belt 460 is connected to the base 470.

Optionally, the lifting module comprises two first driving units 450. The two first driving units 450 drive the respective supporting members 412a, 412b in motion.

In one optional embodiment, the housing is provided with guiding grooves 120. The guiding grooves 120 are the movement paths for guiding the supporting members 412a or 412b.

In the present embodiment, the housing comprises a main housing 100 and an upper plate 130, and the upper plate 130 covers the main housing 100. Two guiding grooves 120 are formed on the main housing 100. Two guiding grooves 120 are disposed on both sides of the upper plate 130 to guide the movement of the supporting members 412a and 412b, respectively. Optionally, one guiding groove 120 is disposed on the main housing 100. In other embodiments, the guiding grooves 120 may also be disposed on the upper plate 130.

In the present embodiment, the upper plate 130 is disposed below the cooling plate 210 and covers the lifting module and the linear module. The upper plate 130 is used to prevent the particles generated during the work of the transmission unit 400 (such as the second driving unit 440) from adhering to the substrate placed on the cooling plate 210.

In one optional embodiment, the transmission arm 410 comprises a pair of arc-shaped supporting portions 415. Each supporting portion 415 comprises at least two projections 411 protruding from the inside of the supporting portion 415. The cooling plate 210 is provided with at least two grooves 220 along the outer circumferential edge. The projections 411 are accommodated in the grooves 220 during the placement or removal of the substrate by the transmission arm 410. Further, the projections 411 are provided with supporting pins 413, and the supporting pins 413 support the substrate. In the present embodiment, a pair of arc-shaped supporting portions 415 have four projections 411, and the cooling plate 210 is provided with four grooves 220 correspondingly.

During the transmission of the substrate, the substrate is easily to slide. Further, the supporting pin 413 is provided with a blocking portion 414, and the blocking portion 414 is in contact with the outer edge of the substrate. The blocking portion 414 can prevent the substrate from deviating from the supporting pin 413.

Further, the heating unit 300 comprises a cover plate 320 that covers the heating plate 310 and forms a closed space. The substrate is heated in the closed space, so as to avoid the heat loss during the heating process. Before the substrate is conveyed above the heating plate 310, the third driving unit (not shown) drives the cover plate 320 to ascend to a preset height. When the substrate is placed on the heating plate 310, the third driving unit drives the cover plate 320 to descend, so as to perform a heating treatment on the substrate.

The first driving unit 450, the second driving unit 440 and the third driving unit in the present application may be cylinders or motors.

Further, the heating unit 300 has three thimble pins 330, and the thimble pins 330 are connected to a fourth driving unit (not shown). The fourth driving unit drives the thimble pins 330 to extend out of the heating plate 310 and support the substrate, or moves downward to the lower part of the heating plate 310 while supporting the substrate, so that the substrate is transferred to the heating plate 310.

In the present invention, the linear module drives the transmission unit 400 to move between the cooling unit 200 and the heating unit 300. The lifting module drives the transmission unit 400 to ascend and descend, so that the substrate receiving apparatus are avoided to dispose at the positions of the cooling unit 200 and the heating unit 300, respectively. The space occupation is reduced, and the internal space of the heat treatment apparatus is optimized.

### Second Embodiment

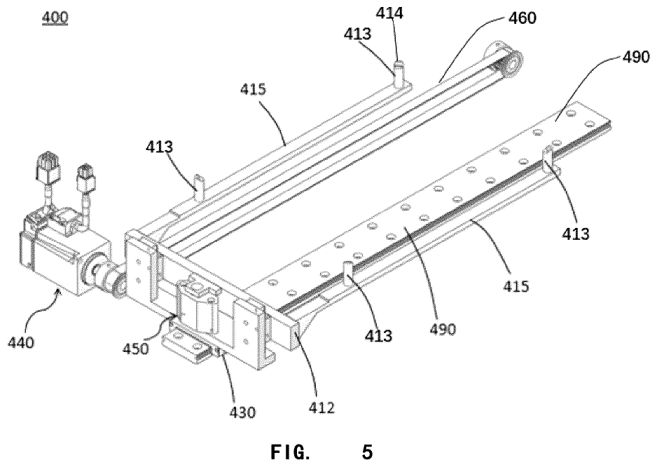

As shown in FIG. 4, the present embodiment provides a heat treatment apparatus that is different from the first embodiment in the structure of the transmission unit 400.

The transmission unit 400 comprises a transmission arm 410, a lifting module, a linear module and two supporting members 412. The lifting module comprises a first driving unit 450 and two first guiding rails 480, and the linear module comprises a second driving unit 440 and a conveyor belt 460.

The linear module further comprises two second guiding rails 490 arranged in parallel and two first moving members 430. The two second guiding rails 490 are respectively disposed on both sides of the conveyor belt 460. And the two first moving members 430 are respectively movably mounted on the respective second guiding rails 490. Both ends of the connector 432 are disposed on the two first moving members 430, and the middle portion of the connector 432 is disposed on the conveyor belt 460, so as to transmit the power of the conveyor belt 460 to the two first moving members 430, so that the second driving unit 440 drives the two first moving members 430 to move on the respective second guiding rails 490, respectively. The first driving unit 450 is disposed on the connector 432, and the two first guiding rails 480 are respectively disposed at two ends of the connector 432. Each supporting member 412 is slidably disposed on the corresponding first guiding rail 480 by the first sliding member 481. The first driving unit 450 drives the two supporting members 412 to ascend and descend, thereby driving the transmission arm 410 to ascend and descend.

The second driving unit 440 drives the lifting module, the supporting members 412 and the transmission arm 410 to move along the two second guiding rails 490 by the two first moving members 430.

In the present embodiment, two supporting members 412 are formed on one frame.

Other arrangements of the present embodiment are the same as the first embodiment, and will not be repeatedly described here.

### Third Embodiment

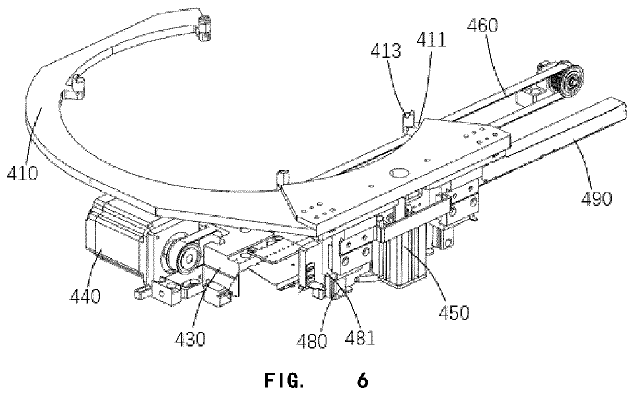

As shown in FIG. 5, the present embodiment provides a heat treatment apparatus, which is different from the second embodiment in that:

The transmission arm 410 comprises a pair of long strip-shaped supporting portions 415. The linear module comprises a second guiding rail 490. Each supporting portion 415 comprises at least two supporting pins 413, and the supporting pin 413 is provided with a blocking portion 414. The cooling plate 210 is provided with two slits (not shown) for accommodating the supporting pins 413. When the first moving member 430 moves on the second guiding rail 490, the supporting pins 413 move within the slits of the cooling plate 210.

Further, the forms of the supporting member 412 is different from the supporting member of the second embodiment, and the supporting member 412 of the present embodiment has strip-shaped plate-like structures. Both ends of the supporting member 412 is respectively connected to the corresponding supporting portion 415.

Other arrangements of the present embodiment are the same as the arrangements of the second embodiment, and will not be repeatedly described here.

### Fourth Embodiment

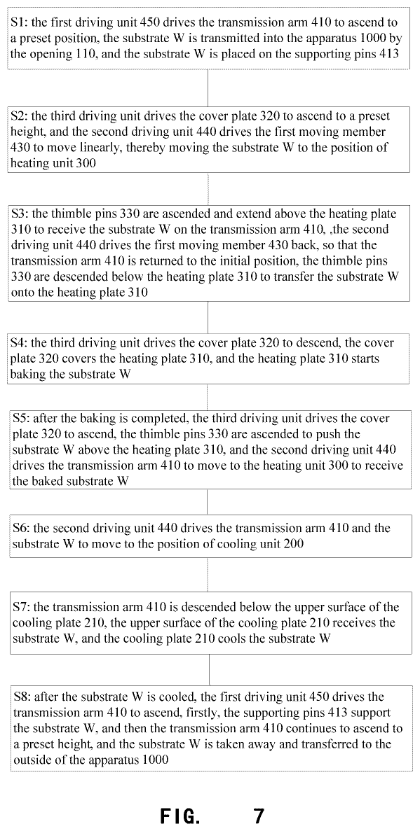

As shown in FIG. 6, the present embodiment provides a heat treatment apparatus, which is different from the third embodiment in that:

The transmission arm 410 is a C-shaped structure, and the C-shaped structure comprises two symmetrical parts. The linear module and the lifting module are centrally disposed below a part of the transmission arm 410. More space is left below the other part of the transmission arm 410 to place other components of the apparatus 1000 while avoiding the interference of the transmission unit 400 with other components. The transmission unit is not disposed with the supporting members 412, and the transmission arm 410 is directly disposed on the first sliding member 481.

The second guiding rail 490 and the conveyor belt 460 are disposed in parallel, and the lifting module is disposed on the side of the second guiding rail 490 away from the conveyor belt 460 and the second driving unit 440. The lifting module comprises two first guiding rails 480, and the first driving unit 450 drives the first sliding member 481 to ascend and descend along the first guiding rail 480. The second driving unit 440 drives the lifting module and the transmission arm 410 to move linearly on the first guiding rail 490.

The transmission arm 410 comprises at least two projections 411 protruding from the inner side of the transmission arm 410. The cooling plate 210 is provided with at least two grooves 220 along the outer circumferential edge. The projections 411 are accommodated in the grooves 220 during the process of placement or removal of the substrate by the transmission arm 410. Further, the projections 411 are provided with supporting pins 413, and the supporting pins 413 support the substrate. In the present embodiment, the transmission arm 410 has four projections 411, and the cooling plate 210 is provided with four grooves 220 correspondingly.

### Fifth Embodiment

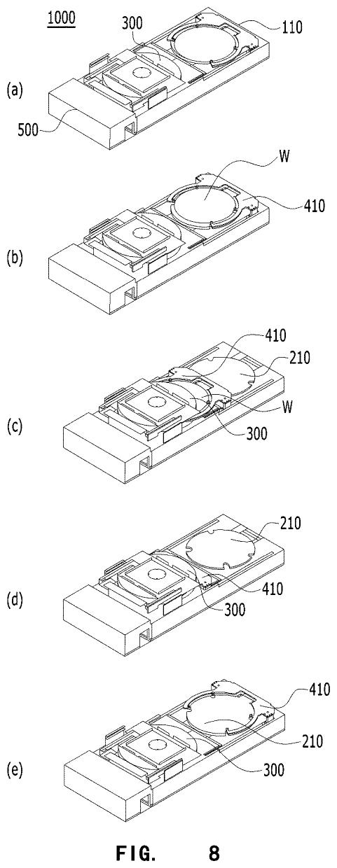

As shown in FIGS. 7-8, the present embodiment provides an exemplary transmission method of the heat treatment apparatus according to the heat treatment apparatus from the first embodiment to the fourth embodiment. In FIG. 8, the diagram (a) shows the state of the apparatus is not working. The diagram (b) shows the work state when the transmission arm 410 is ascended to load and support the substrate W. The diagram (c) shows the work state when the transmission unit 400 transmits the substrate W to the heating unit 300. The diagram (d) shows the work state when the transmission unit 400 is returned after the heating unit 300 receives the substrate W. The diagram (e) shows the work state when the heating unit 300 bakes the substrate W after the transmission arm 410 is returned to the initial position.

### Referring to FIGS. 1-2 and 7-8, the Specific Steps Comprise:

S1: The first driving unit 450 drives the transmission arm 410 to ascend to a preset position. The substrate W is transmitted into the apparatus 1000 by the opening 110, and the substrate W is placed on the supporting pins 413, referring to FIG. (b);
S2: The third driving unit (not shown) drives the cover plate 320 to ascend to a preset height, and the second driving unit 440 drives the first moving member 430 to move linearly, thereby moving the substrate W to the position of heating unit 300, referring to FIG. (c);
S3: The thimble pins 330 are ascended and extend above the heating plate 310 to receive the substrate W on the transmission arm 410. The second driving unit 440 drives the first moving member 430 back, so that the transmission arm 410 is returned to the initial position. The thimble pins 330 are descended below the heating plate 310 to transfer the substrate W onto the heating plate 310, referring to FIG. (d);
S4: The third driving unit drives the cover plate 320 to descend, the cover plate 320 covers the heating plate 310, and the heating plate 310 starts baking the substrate W, referring to FIG. (e);
S5: After the baking is completed, the third driving unit drives the cover plate 320 to ascend. The thimble pins 330 are ascended to push the substrate W above the heating plate 310, and the second driving unit 440 drives the transmission arm 410 to move to the heating unit 300 to receive the baked substrate W;
S6: The second driving unit 440 drives the transmission arm 410 and the substrate W to move to the position of cooling unit 200;
S7: The transmission arm 410 is descended below the upper surface of the cooling plate 210. The upper surface of the cooling plate 210 receives the substrate W, and the cooling plate 210 cools the substrate W;
S8: After the substrate W is cooled, the first driving unit 450 drives the transmission arm 410 to ascend. Firstly, the supporting pins 413 support the substrate W, and then the transmission arm 410 continues to ascend to a preset height, and the substrate W is taken away and transferred to the outside of the apparatus 1000.

The above steps S1-S8 are repeated for the next substrate W.

The above methods only illustrate and describe the substrate transmission method of the heat treatment apparatus of the present invention, and it can be understood that the substrate can have different transmission methods based on the heat treatment apparatus of the present invention according to different process requirements.

The above embodiments are merely used to describe the technical solutions of the present invention, and are not intended to limit the technical solutions. Although the present invention has been described in detail with reference to the aforementioned embodiments, those of ordinary skill in the art should understand that the technical solutions described in the aforementioned embodiments may be modified, or some technical features may be equivalently replaced. However, these modifications or substitutions do not deviate the essence of the corresponding technical solutions from the spirit and scope of the technical solutions of each embodiment of the present invention.

What is claimed is:

1. A heat treatment apparatus, comprising a cooling unit (200), a heating unit (300) and a transmission unit (400);
the cooling unit (200) comprising a cooling plate (210) for cooling a substrate, the heating unit (300) comprising a heating plate (310) for heating the substrate;
the transmission unit (400) comprising a transmission arm (410), a lifting module and a linear module, the transmission arm (410) being movably disposed on the lifting module, and the lifting module being disposed on the linear module;
the transmission arm (410) being used to support the substrate, the lifting module being used to drive the transmission arm (410) to ascend and descend, and the linear module being used to drive the transmission arm (410) to transmit the substrate between the cooling plate (210) and the heating plate (300).

2. The heat treatment apparatus according to claim 1, wherein the linear module comprises a second driving unit (440) and a second guiding rail (490), the second driving unit (440) is used to drive the lifting module and the transmission arm (410) to slide on the second guiding rail (490).

3. The heat treatment apparatus according to claim 2, wherein the linear module further comprises a first moving member (430), the lifting module is disposed on the first moving member (430), the first moving member (430) is movably mounted on the second guiding rail (490), and the second driving unit (440) drives the first moving member (430) to slide on the second guiding rail (490).

4. The heat treatment apparatus according to claim 3, wherein the transmission unit (400) comprises a supporting member (412a), and one side of the supporting member (412a) is disposed on the transmission arm (410);
the lifting module comprises a first driving unit (450), the first driving unit (450) comprises a second sliding member and a driving member, the other side of the supporting member (412a) is disposed on the second sliding member, the driving member drives the second sliding member to slide up and down, so as to drive the transmission arm (410) to ascend and descend.

5. The heat treatment apparatus according to claim 4, wherein the linear module further comprises a second moving member (431) and an auxiliary guiding rail (420), the lifting module further comprises a first sliding member (481) and a first guiding rail (480), the first sliding member (481) is slidably disposed on the first guiding rail (480), the first guiding rail (480) is disposed on the second moving member (431), and the transmission unit (400) further comprises another supporting member (412b), two sides of the other supporting member (412b) are respectively disposed on the transmission arm (410) and the first sliding member (481);
the auxiliary guiding rail (420) is disposed at an interval from the second guiding rail (490), and the second moving member (431) is movably disposed on the auxiliary guiding rail (420), the second driving unit (440) drives the second moving member (431) to slide on the auxiliary guiding rail (420) and the first moving member (430) to slide on the second guiding rail (490) at the same time.

6. The heat treatment apparatus according to claim 1, wherein the transmission arm (410) is provided with at least two projections (411);
the cooling plate (210) is provided with at least two grooves (220) along the outer circumferential edge, the projections (411) are accommodated in the grooves (220) during the process of placing or supporting the substrate by the transmission arm (410), and the projections (411) are provided with supporting pins (413), and the supporting pins (413) are used to support the substrate.

7. The heat treatment apparatus according to claim 6, wherein a blocking portion (414) is provided on the supporting pin (413), the blocking portion (414) is in contact with the outer edge of the substrate for preventing the substrate from deviating from the supporting pin (413).

8. The heat treatment apparatus according to claim 3, wherein the linear module comprises a connector (432), two second guiding rails (490) arranged in parallel and two first moving members (430), the transmission unit (400) comprises two supporting members (412), one side of the two supporting members (412) are disposed on the transmission arm (410), the lifting module comprises a first driving unit (450), two first sliding members (481) and two first guiding rails (480);
two ends of the connector (432) are respectively disposed on the two first moving members (430), the two first moving members (430) are respectively movably mounted on the respective second guiding rails (490), the second driving unit (440) drives the two first moving members (430) to move linearly;
the first driving unit (450) is disposed on the connector (432), and the two first guiding rails (480) are respectively disposed on two ends of the connector (432), and the supporting members (412) are slidably mounted on the corresponding first guiding rails (480) by the first sliding members (481).

9. The heat treatment apparatus according to claim 1, wherein the transmission arm (410) comprises a pair of strip-shaped supporting portions (415), the supporting portions (415) are disposed below the cooling plate (210), each supporting portion (415) comprises at least two supporting pins (413) for supporting the substrate, the cooling plate (210) comprises two slits for accommodating the supporting pins (413).

10. The heat treatment apparatus according to claim 6, wherein the transmission arm (410) comprises a pair of arc-shaped supporting portions (415), each supporting portion (415) comprises at least two projections (411) protruding from the inner side of the supporting portion (415).

11. The heat treatment apparatus according to claim 1, further comprising an upper plate (130), the upper plate (130) being disposed below the cooling plate (210) and covering the lifting module and the linear module.

12. The heat treatment apparatus according to claim 1, further comprising a housing, the cooling unit (200), the heating unit (300) and the transmission unit (400) being disposed in the housing, the housing having at least one guiding groove (120), the transmission unit (400) transmitting the substrate along the guiding grooves.

13. The heat treatment apparatus according to claim 3, wherein the transmission arm (410) is a C-type structure, wherein the C-type structure comprises two symmetrical parts, the linear module and the lifting module are centrally disposed below a portion of the transmission arm (410), the lifting module is disposed on one side of the second guiding rail (490) away from the second driving unit (440).

14. The heat treatment apparatus according to claim 13, wherein the lifting module comprises a first driving unit (450), two first sliding members (481) and two first guiding rails (480), the transmission arm (410) is disposed on the first sliding members (481), and the first driving unit (450) drives the first sliding members (481) to ascend and descend along the first guiding rails (480).
